(19) United States
(12) Patent Application Publication
(10) Pub. No.: US 2009/0287571 A1
(43) Pub. Date: Nov. 19, 2009

(54) Hypervisor and virtual machine ware

(76) Inventor: Robb Fujioka, Manhattan Beach, CA (US)

Correspondence Address: Thomas J. McWilliams, Esquire;Drinker Biddle & Reath LLP, One Logan Square, 18th and Cherry Streets, Philadelphia, PA, 19103-6996, US

(21) Appl. No.: 12/381,666

(22) Filed: Mar. 12, 2009

Related U.S. Application Data
(60) Provisional application No. 61/070,942, filed on Mar. 26, 2008.

(51) Int. Cl. G06F 9/00; G06Q 30/00; G06F 3/00; G06F 3/048; G06F 9/455

(52) U.S. Cl. 705/14.54; 713/2; 705/14.4; 705/14.49; 705/14.53; 715/700; 715/769; 718/1

(57) ABSTRACT

An apparatus, system and method for an instant-on environment. The apparatus, system and method may include a hypervisor instantiated by a BIOS, at least one application space instantiated by the hypervisor in parallel to, and prior to complete boot of, at least one main operating system, and a graphical user interface including at least one application software, which at least one application software includes at least one embedded content, launched within said at least one application space.

### CROSS-REFERENCE TO RELATED APPLICATIONS

This application claims priority to U.S. Provisional Application Ser. No. 61/070-942, filed Mar. 26, 2008 and entitled “Hypervisor and Virtual Machine Ware, which is incorporated by reference as if set forth herein in the entirety.

### BACKGROUND OF THE INVENTION

a. Field of the Invention

The instant invention relates to the field of computers, and in particular to allowing multiple operating systems to run on a host computer simultaneously.

b. Description of Related Art

In computing, a hypervisor, which is sometimes referred to as a virtual machine monitor, is a virtualization platform that allows multiple operating systems to run on a host computer at the same time. There traditionally have been two types of hypervisors: (1) software that runs directly on a given hardware platform (as an operating system control program), such as an operating system thus runs at the second level above the hardware. (2) is software that runs within an operating system environment, such as an operating system thus runs at the third level above the hardware.

The first type of hypervisor is software that runs directly on a given hardware platform (as an operating system control program). A guest operating system thus runs at the second level above the hardware. The classic type 1 hypervisor was CP/CMS, developed at IBM in the 1960s, ancestor of IBM's current z/VM. More recent examples are Xen, Oracle VM, VMware's ESX Server, L4 microkernels, TRANGO, IBM's LPAR hypervisor (PR/SM), Microsoft's Hyper-V (currently in Beta), and Sun's Logical Domains Hypervisor (released in 2005).

A Type 2 (or hosted) hypervisor is software that runs within an operating system environment. A “guest” operating system thus runs at the third level above the hardware. Examples include VMware Server (formerly known as GSX), VMware Workstation, VMware Fusion, the open source QEMU, Microsoft's Virtual PC and Microsoft Virtual Server products, InnoTek's VirtualBox, as well as SWsoft's Parallels Workstation and Parallels Desktop.

The term hypervisor call, or hypercall, referred to the paravirtualization interface, by which a “guest” operating system could access services directly from the (higher-level) control program—analogous to making a “supervisor call” to the (same level) operating system. (The term “supervisor” refers to the operating system kernel, which on IBM mainframes runs in supervisor state.)

By running multiple operating systems simultaneously, the hypervisor increased system robustness and stability: Even if one operating system crashed, the others would continue working without interruption. Indeed, this even allowed beta or experimental versions of operating systems—or even of new hardware—to be deployed and debugged, without jeopardizing the stable main production system, and without requiring costly additional development systems.

Several factors led to a resurgence in the use of virtualization technology among UNIX and Linux server vendors:

Expanding hardware capabilities, allowing more simultaneous work to be done per machine

Efforts to control costs and simplify management through consolidation of servers

The need to control large multiprocessor and cluster installations, e.g. in server farms and render farms

The improved security, reliability, and device independence possible from hypervisor architectures

The desire to run complex, OS-dependent applications in different hardware or OS environments

The major UNIX vendors, including Sun Microsystems, HP, IBM, and SGI, have been selling virtualized hardware since before 2000. These have generally been large systems with hefty, server-class price tags (in the multi-million dollar range at the high end), although virtualization is also available on some mid-range systems, such as IBM's System-P servers and Sun's CoolThreads T1000, T2000 and T5x00 servers.

Interest in the high-profit server hardware market sector has led to the development of hypervisors for the Intel x86 instruction-set machines, including traditional desktop PCs. One of the early PC hypervisors was the commercial VMware, introduced in 1998. Parallels, Inc. introduced Parallels Workstation, which is primarily used on PCs, in 2005 and Parallels Desktop for Mac, which runs on Mac OS X, in 2006. The x86 architecture used in most PC systems is particularly difficult to virtualize. Full virtualization (presenting the illusion of a complete set of standard hardware) on x86 has significant costs in hypervisor complexity and runtime performance.

An alternative approach requires that the guest operating system be modified to make system calls to the hypervisor, rather than executing machine I/O instructions which are then simulated by the hypervisor—paravirtualization. VMware supplements the slowest rough corners of virtualization with device drivers for the guest.

CPU vendors have added hardware virtualization assistance to their products. Intel's is called VT (codenamed Vanderpool), AMD's is referred to as AMD Virtualization or AMD-V (codename: Pacifica). These extensions address the parts of x86 that are difficult or inefficient to virtualize, providing additional support to the hypervisor. This enables simpler virtualization code and a higher performance for full virtualization.

Others, like Xen, are implemented as software-only virtual machines. Xen is running on a normal host operating system such as Linux, and is able to run both paravirtualized and, with the help of the hardware virtualization extensions Intel VTx, fully virtualized (i.e. an unmodified operating system) as guest operating systems. In fact, Xen has successfully demonstrated Windows XP running unmodified. The Xen distribution already contains versions of FreeBSD, Linux, NetBSD, and Plan 9 from Bell Labs that have been so modified. User programs will continue to work on Xen without change. Also, Xen is being re-implemented on an OpenSolaris kernel—the result is called Sun xVM Server.

Virtual machines have recently appeared in embedded systems, such as mobile phones. This is driven by the desire to provide a high-level operating-system interface for application programming, such as Linux or Microsoft Windows, while at the same time maintaining traditional real-time operating system (RTOS) APIs. The low-level RTOS environments need to be retained for legacy support, and because the real-time capabilities of high-level OSes are insufficient for many embedded applications.

Hypervisors for embedded use must therefore be real-time capable, a design criterion not present for hypervisors used in other domains. The resource-constrained nature of many embedded systems, especially battery-powered mobile systems, imposes a further requirement for small memory size and low overhead. Finally, in contrast to the ubiquity of the x86 architecture in the PC world, the embedded world uses a wider variety of architectures. Support for virtualization requires memory protection (in the form of a memory management unit or at least a memory protection unit) and a distinction between user mode and privileged mode, which rules out most microcontrollers. This still leaves x86, MIPS, ARM and PowerPC as widely-deployed architectures on medium- to high-end embedded systems.

As embedded-system manufacturers usually have source code to their operating systems, there is less need for full virtualization in this space. Instead, the performance advantages of paravirtualization make this the virtualization technology of choice.

### SUMMARY OF THE INVENTION

The present invention advantageously provides an apparatus, system and method for an instant-on environment that may be provided in the range of 8-14 seconds from an initial computing boot. The apparatus, system and method may include a hypervisor instantiated by a BIOS, at least one application space instantiated by the hypervisor in parallel to, and prior to complete boot of, at least one main operating system, and a graphical user interface including at least one application software, which at least one application software includes at least one embedded content, launched within said at least one application space.

Thus, the present invention may provide embedded content, including widgets and/or advertisements, and a fully realizable virtual ware system, in an instant-on environment.

### BRIEF DESCRIPTION OF THE DRAWINGS

The present invention will be described in conjunction with the following figures, wherein like numerals denote like aspects of the invention, and wherein:

FIG. 1 is a block diagram illustrating the hypervisor and virtual machine ware of the present invention;

FIG. 2 illustrates an aspect of the present invention;

FIG. 3 illustrates an aspect of the present invention;

FIG. 4 illustrates an aspect of the present invention;

FIG. 5 is a flow diagram illustrating an aspect of the present invention;

FIG. 6 illustrates an aspect of the present invention;

FIG. 7 illustrates an aspect of the present invention;

FIG. 8 illustrates an aspect of the present invention;

FIG. 9 illustrates an aspect of the present invention;

FIG. 10 illustrates an aspect of the present invention;

FIG. 11 illustrates an aspect of the present invention;

FIG. 12 is a flow diagram illustrating an aspect of the present invention;

FIG. 13 illustrates an aspect of the present invention;

FIG. 14 illustrates an aspect of the present invention;

FIG. 15 illustrates an aspect of the present invention;

FIG. 16 is a flow diagram illustrating an aspect of the present invention;

FIG. 17 illustrates an aspect of the present invention;

FIG. 18 illustrates an aspect of the present invention;

FIG. 19 illustrates an aspect of the present invention;

FIG. 20 illustrates an aspect of the present invention;

FIG. 21 illustrates an aspect of the present invention;

FIG. 22 illustrates an aspect of the present invention;

FIG. 23 illustrates an aspect of the present invention;

FIG. 24 illustrates an aspect of the present invention;

FIG. 25 illustrates an aspect of the present invention;

FIG. 26 illustrates an aspect of the present invention;

FIG. 27 illustrates an aspect of the present invention;

FIG. 28 illustrates an aspect of the present invention;

FIG. 29 illustrates an aspect of the present invention;

FIG. 30 illustrates an aspect of the present invention;

FIG. 31 illustrates an aspect of the present invention;

FIG. 32 illustrates an aspect of the present invention; and

FIG. 33 illustrates an aspect of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purpose of clarity, many other elements found in typical computer systems. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art. Furthermore, the embodiments identified and illustrated herein are for exemplary purposes only, and are not meant to be exclusive or limited in their description of the present invention.

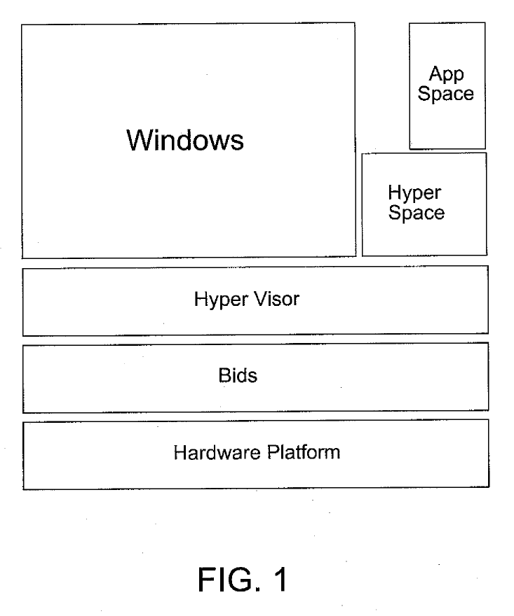

Referring now to FIG. 1, there is shown a block diagram illustrating an embodiment of a hypervisor presenting virtual machine ware, according to an aspect of the present invention. As may be seen in FIG. 1, there is shown diagrammatically the relationship between the BIOS, a hypervisor according to an aspect of the present invention, an operating system, and application software presented by one or more application spaces instantiated by the hypervisor.

As is generally understood in the pertinent art, BIOS stands for Basic Input/Output System. BIOS refers to the firmware code run by an IBM PC when first powered on. The primary function of the BIOS is to identify and initiate component hardware, such as hard disk, floppy and optical disk drives, by way of non-limiting example only. This identifying and initiating is to prepare the machine so that other software programs stored on various media may load, execute, and assume control of the PC. This process is known as booting, or booting up, which is short for bootstrapping.

Further, for example, BIOS may also be and/or include a coded program embedded on a chip that recognizes and controls various hardware, firmware or software devices that make up a PC.

The BIOS typically runs from a PROM, EPROM or, most commonly, flash memory when the computer is powered on. It initializes several motherboard components and peripherals, including:

Clock generator;
Processors and caches;
Chipset—memory controller and I/O controller;
System memory;
PCI devices—by assigning bus numbers and resources;
Primary graphics controller;
Mass storage controllers; and
Various I/O controllers including keyboard/mouse and USB.

Finally, the BIOS preferably loads the boot loader for the operating system of a PC, and transfers control to it. The entire process is known as power-on self-test (POST). Once system memory is initialized, the BIOS typically copies/decompresses itself into system memory and continues executing from therein. Nearly all recent BIOS implementations may optionally execute a setup program interfacing the nonvolatile BIOS memory. This memory holds user-customizable configuration data (passwords, time, date, hard drive details, etc.) accessed by BIOS code. In most modern BIOS implementations, users select where the BIOS obtains its boot image: CD, hard disk, floppy disk, USB device or via a networked connection. This is particularly useful for installing operating systems or booting to a LiveCD or flash keydrive, for example, and for selecting the order of testing for the presence of bootable media. Some BIOS allow the user to select the operating system (“OS”) to load (e.g. loading a secondary OS from a second hard disk), though this is more often handled by a second-stage boot loader.

Referring now to the operating system of FIG. 1, the operating system (OS) is generally the software that manages the resources of a computer and provides programmers with an interface to access those resources. An operating system processes system data and user input, and responds by allocating and managing tasks, applications and internal system resources as a service to users and programs of the system. An operating system performs basic tasks such as controlling and allocating memory, prioritizing system requests, controlling input and output devices, facilitating computer networking and managing applications and files. Operating systems as used herein may be found on almost anything made with integrated circuits, such as personal computers, internet servers, cell phones, music players, routers, switches, wireless access points, network storage, game consoles, digital cameras, sewing machines and telescopes.

Creation of a process involves allocating memory space for the process, loading the program's executable code into memory, telling the scheduler to run the program, and other tasks specific to the operating system. The scheduler is the portion of the operating system that causes the program to be executed on the CPU, that is, ‘scheduled’ for execution. If the scheduler supports preemptive multitasking, it can change the program currently executing on the CPU to that of another program when it determines that the first program has executed for a predetermined amount of time. The amount of time allocated to a given process may depend on the needs of the process in question and the user's priority level for that process. Destroying a process involves releasing any resources held by the program and ensuring that a different program is scheduled for execution.

Current computer architectures arrange the computer's system in a hierarchical manner, starting from the fastest registers, CPU cache, random access memory and disk storage. An operating system's disk manager coordinates the use of these various types of memory by tracking which one is available, which is to be allocated or deallocated, and how to move data between them. This activity, usually referred to as virtual memory management, increases the amount of memory available for each process by making the disk storage seem like main memory. There is a speed penalty associated with using disks or other slower storage as memory—if running processes require significantly more RAM than is available, the system may start thrashing. This can happen either because one process requires a large amount of RAM or because two or more processes compete for a larger amount of memory than is available. This then leads to constant transfer of each process's data to slower storage.

Another important part of memory management is managing virtual addresses. If multiple processes are in memory at once, they must be prevented from interfering with each other's memory (unless there is an explicit request to utilize shared memory). This is achieved by having separate address spaces. Each process sees the whole virtual address space, typically from address 0 up to the maximum size of virtual memory, as uniquely assigned to it. The operating system maintains a page table that matches virtual addresses to physical addresses. These memory allocations are tracked so that when a process terminates, all memory used by that process can be made available for other processes.

Generally, operating systems include support for file systems, which allow the user to segment a given area of memory into individual files, include a hierarchy of directories.

Current operating systems generally support a variety of networking protocols. Most are capable of using the TCP/IP networking protocols, for example. This means that computers running dissimilar operating systems can participate in a common network for sharing resources such as computing, files, printers, and scanners using either wired or wireless connections.

Many operating systems include some level of security. Security is based on two concepts: The operating system provides access to a number of resources, directly or indirectly, such as files on a local disk, privileged system calls, personal information about users, and the services offered by the programs running on the system; the operating system is capable of distinguishing between some requesters of these resources who are authorized (allowed) to access the resource, and others who are not authorized (forbidden). While some systems may simply distinguish between “privileged” and “non-privileged”, systems commonly have a form of requester identity, such as a user name.

A device driver is a specific type of computer software developed to allow for interaction with hardware devices. Typically this constitutes an interface for communicating with the device through the specific computer bus or communications subsystem that the hardware is connected to, providing commands to and/or receiving data from the device, and, on the other end, providing the requisite interfaces to the operating system and software applications. It is a specialized, hardware-dependent computer program which is operating system specific and that enables another program, typically an operating system or applications software package or computer program running under the operating system kernel, to interact transparently with a hardware device, and that usually provides the requisite interrupt handling necessary for any necessary asynchronous time-dependent hardware interfacing needs.

Referring now to the application space of FIG. 1, application software is a subclass of computer software that employs the capabilities of a computer directly and thoroughly to a task that the user wishes to perform. This should be contrasted with system software which is involved in integrating a computer's various capabilities, but typically does not directly apply them in the performance of tasks that benefit the user. In this context, the term application refers to both the application software and its implementation.

Referring now to the hypervisor, the hypervisor is, as discussed hereinabove, a virtualization platform that allows multiple operating systems to run on a host computer at the same time, and/or that coordinates multiple actions, such as between and among the BIOS, application space within hyperspace, and a core. A hypervisor may, for example, enable a second operating system to simultaneously perform process management, memory management, disk and file systems, networking, security, and device drivers as discussed herein throughout.

Hyperspace is an operating environment, that is, a layer on top of the BIOS, that may run side-by-side with Windows or another operating system to more efficiently implement some of the most commonly used apps on a PC by instantiating a hypervisor to implement control of certain hardware, such as through a core to the BIOS, and certain software, such as that resident in an application space within the hyper space. There may be several benefits to running and operating in the hyperspace created by a hypervisor. First, moving some of the applications that inadvertently slow down the first operating system, such as Windows for example, such as antivirus and malware-scanning utilities, out of the first operating system altogether and into an application space for such applications within the hyperspace may create efficiency in the first operating system. Such efficiencies may be created by reducing the overhead in the first operating system. Further, the hyperspace may be able reduce the power usage in view of certain uses of the application space, such as through an interaction down through the BIOS to hardware, which may have increased importance particularly in a laptop environment.

Further, management of the computer overall may be shifted to the hyperspace. This, in addition to the operating efficiencies that may be created, may also lead to increased security and better maintenance of the computer. The maintenance of the computer and efficiencies that are created therefrom are discussed in more detail herein below. With respect to the increased security, it may be well understood to those with ordinary skill in the pertinent that standard operating systems secure themselves by protecting from within. A hyperspace environment that contains security protections, at least in part, may be able to protect from without, or around, the first operating system. This hyperspace may be thus able to create a “perimeter” that makes penetration to the first operating system more difficult. Such a perimeter may also enhance the protections found within the first operating system because those breaches that are rejected by the perimeter need not be considered, that is, only breaches of the perimeter need be accounted for by the first operating system.

A web property that may create a neutral platform for consolidation aggregation and integration of a user's favorite websites and web based applications may run as an application within the application space. This property may be a webtop which functions and behaves much like a traditional PC desktop. However, this webtop may run entirely inside a traditional web browser, and its functionality may, via hyperspace, not be limited to a single device or platform. For example, creating a drag and drop functionality for accessing content, this webtop may provide a centralized storage and access point for all content and, web applications a user desires. A user may be thus able to access favorite web properties, including multiple sites, IM services, VoIP services, email accounts, and social networking sites to name a few, from hyperspace. The webtop may thus offer users drag-and-drop content functionality, web-based centralized storage, and collaboration tools.

The webtop may utilize a core structure based on life-segment and present dynamic data triggered by key life events. By dividing the webtop into segments (work, family, entertainment, and community), marketing, advertising and strategic channels and partnerships may be better developed.

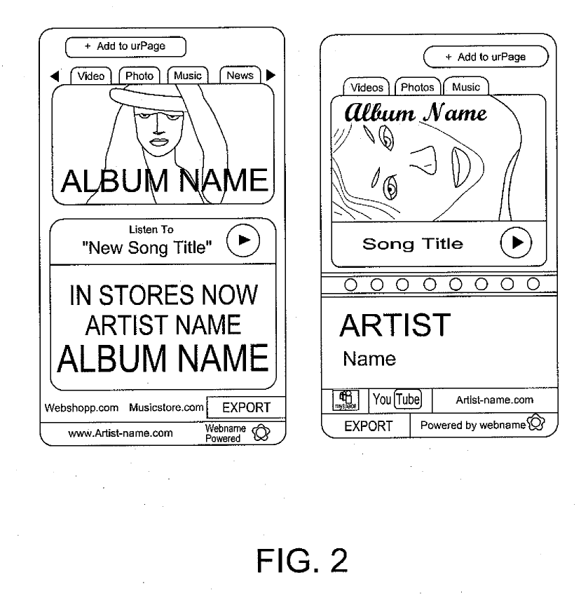

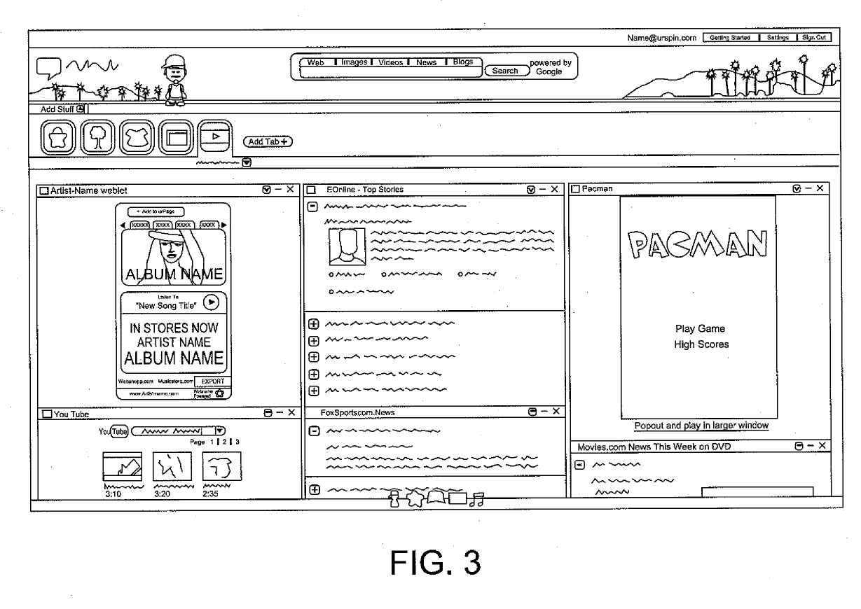

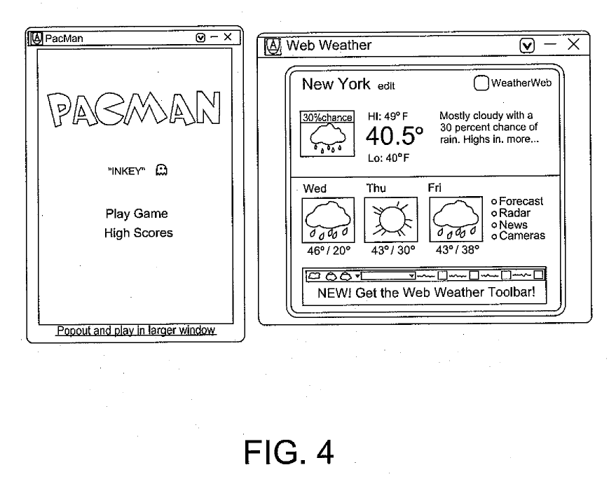

Thus, in a given environment, an active state in which certain computing capability is available may be provided in the range of 8-14, and more specifically 10-12, seconds, such as with or without the use of a webtop. In fact, in certain of the aforementioned embodiments wherein a simplistic instant-on desktop, such as a web-top, is provided, numerous functionalities may be provided via non-conventional means, such as by widgetization, such as wherein one or applications, functions, or the like are prepared to run in the instant-on environment. For example, a user may pre-select certain widgets that are to run at instant-on startup, such as those shown in FIGS. 2, 4, 6 and 7, either from the hypervisor on an operational environment provided by the hypervisor, or on the webtop solution accessed by the hypervisor over a network, as is shown in FIG. 3.

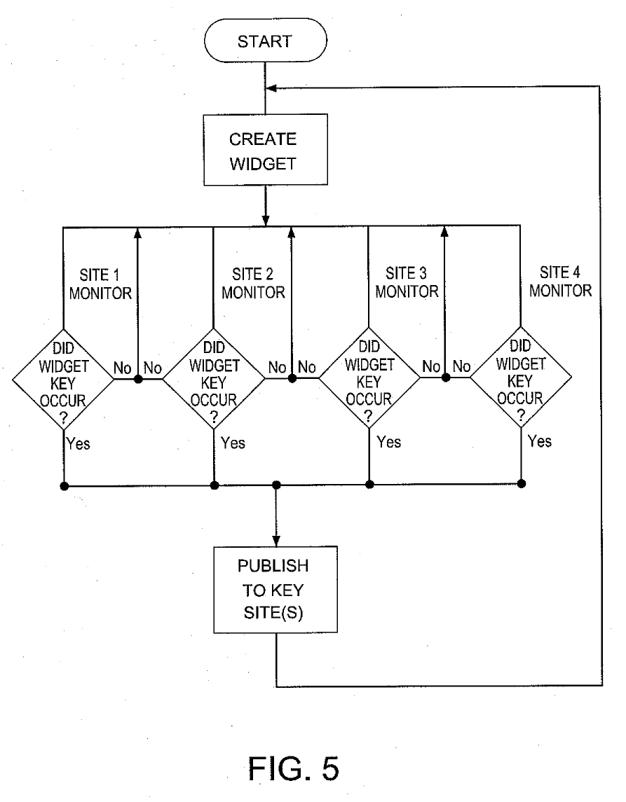

Alternatively and additionally, the provider may, for example, embed solutions to run in the instant-on environment, either as instructed by the hypervisor or as an aspect of a webtop overseen by the hypervisor. For example, the aforementioned widgets may be embedded, and may run automatically upon instant-on startup. Such a widget may include any type of monetization widget, such as one that runs advertisements, such as banner ads or pop up ads that may, or may not, be targeted based on known preferences of the user, as is illustrated in FIG. 5. Such preferences may be known by access from the hypervisor environment, for example, into “cookie” files stored either by the hypervisor or by a main operating system, when in use.

Similarly, such a solution may be embedded by a provider within, or not in association with, a widget. For example, such an instant-on may provide a limited search capability at start, and such a search capability may be associated with an embedded search engine with, for example, an affiliate sponsor. Of course, in the event such an instant-on boot to a search engine is performed, the search engine may include, in the instant-on environment, tools typically associated with search engines, and search results, in non-instant-on environments, such as banner ads, pop-up ads, text ads, and the like, provided via either a network link to the search capability, via one or more dedicated ad servers for instant-on machines (which will, of course, sense the presence of a network link to an instant-on environment in accordance with the present invention), via one or embedded advertisements, via one or more advertisement widgets having associated therewith cookies or information regarding the computer user and capable of using that information to pull targeted advertisements from one or more ad servers on the network, or the like. Additional widget embodiments in the instant-on environment of the present invention are discussed hereinbelow.

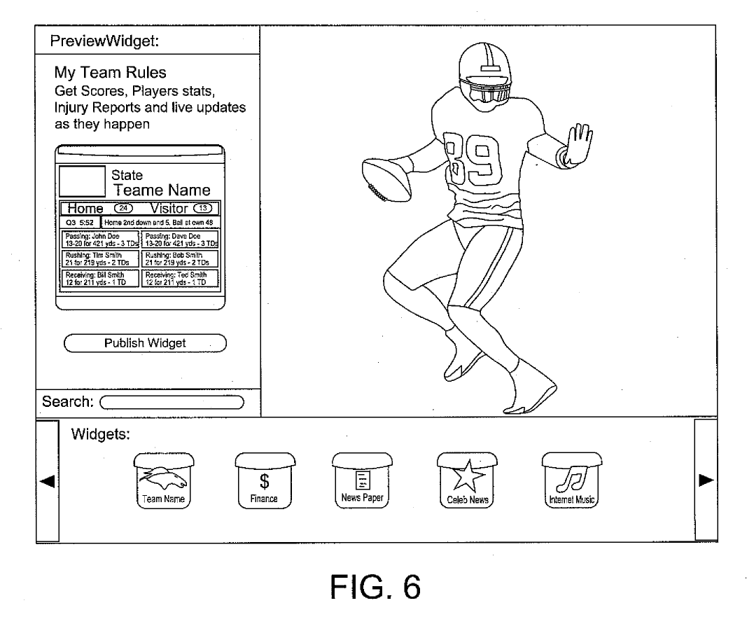

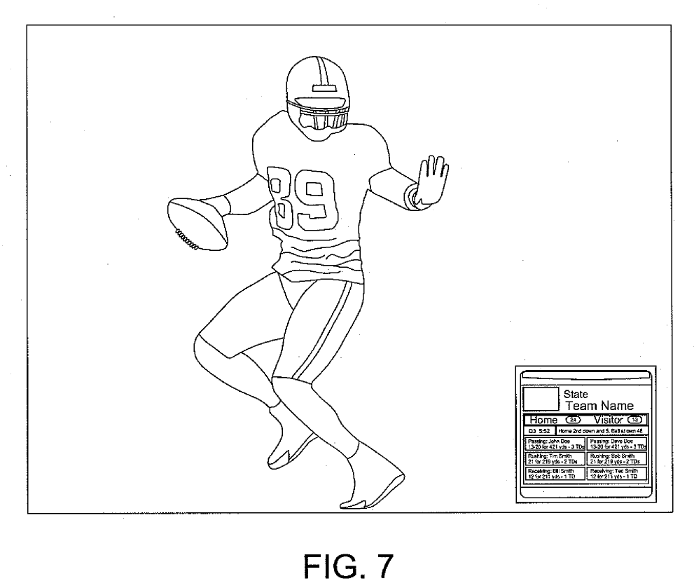

In additional webtop related exemplary embodiments, the hyperspace webtop may, for example, incorporate a video channel with niche content to be supplied, such as is shown in FIGS. 6 and 7. The hyperspace webtop may be able to capitalize more aggressively on advertising revenue when this content is viewed either on the webtop or video channel, such as due to the fact that the instantiation into hyperspace of this webtop “hard codes” this webtop into the BIOS, thus meaning this process and the desired manner of presentations, such as advertisements, cannot be changed by the user. The webtop may also provide opportunities to generate revenue by selling “Tabs” on the webtop to content providers who want to create their own sub-experience within the webtop. Such tabs and the overall webtop may be driven by life segments, including work, family, friends, and entertainment. The user's content may be organized according to these categories and may be customized or expanded by the user. Content may be populated through the user's personal profile as well as through a “directory” system that facilitates the discovery and addition of content or applications.

The webtop may be integrated into the operating system, such as via a presence in the application space of a hypervisor, to mandate presentation to the user upon turning on the computer. This means the user will be presented with the webtop every time the computer is turned on and it becomes a “cover page” which is ultimately the most attractive place for marketer penetration and revenue generation. The webtop may provide new applications and insight into what applications other people with similar interests are finding useful. The value of this will be enhanced through other avenues as the user may seek information or content advice from people with similar interests in a social network.

By operating a hypervisor on a computer the computing experience may become more predictable more secure. Employing such actions in instant-on may further enhance security. For example, the instant-on may require a thumbprint authorization at boot, by way of non-limiting example only. Operating a hypervisor with specialized core services in parallel with the first operating system may thus allow for design and maximization of secure functions, including: ad revenue/serving; website direction; computer security; computer stability; increased efficiency; instant-on; battery efficiencies; and direct access to peripheral devices such as DVD player and the like.

According to an aspect of the present invention, the current hypervisor may be configured to provide instant-on capabilities. In such a configuration, a platform, such as LINUX, for example, may be used to provide quick boot capability allowing a user to, instead of waiting while the computer boots up, to quick-boot and check email, instant message, surf the web, play videos, download data, and other common functions, via the hypervisor webtop. Such instant on capability need not contain the ability to perform all types of computing functionality, instead providing a limited subset of functionality that may be designed around those functions that are often the first accessed after boot up. In this way, the boot up process time may be utilized to perform those functions that are initiated upon completion of the boot routine, thereby increasing efficiency and utilizing more fully the computer processing ability. Thus instant-on configuration may enable instant user gratification. Further, it may provide an avenue through which locking startup pages and the like may direct traffic to certain designed sites and links.

Such instant-on technology may be able to boot to the hypervisor webtop in a timeframe of a few seconds, one second, or even at a sub-second level, for example. This instant-on technology may be embedded within the BIOS as described hereinabove, and may be overseen by the hypervisor. This instant-on technology may be designed to mimic that found in other electronic devices, for example.

In light of the discussion herein, those skilled in the art will appreciate the myriad of virtualization capabilities provided by the present invention, particularly in instant-on embodiment. For example, the hypervisor can direct that the hypervisor webtop link, such as via a hypervisor-directed BIOS executed communication link, with a remote server. Thereby, full desktop functionality, with server access and communication, can be provided by the webtop, and can, in instant on embodiments, be instantly provided by the webtop.

Of course, such functionality, and particularly such comprehensive instant on functionality, can be provided in part based on a reliance, by the hypervisor, on the remote, “virtual” server for the processing power necessary to provide such comprehensive processing capabilities without excessive loss of local processing and boot capabilities, such as during instant on. As such, such embodiments may act as “thin client”, but unlike typical thin client propositions, may make available the full processing of the application space and the virtual server as overseen by the hypervisor. More specifically, the hypervisor of the present invention may communicatively link, such as by directing the BIOS to link, an application space within the hyperspace to a server, thereby providing optimal functionality with limited local processing resources. Certain of the applications discussed above, that may be presented in the aforementioned hypervisor webtop or in an additional or alternative browser window within or without the hypervisor, are discussed hereinbelow.

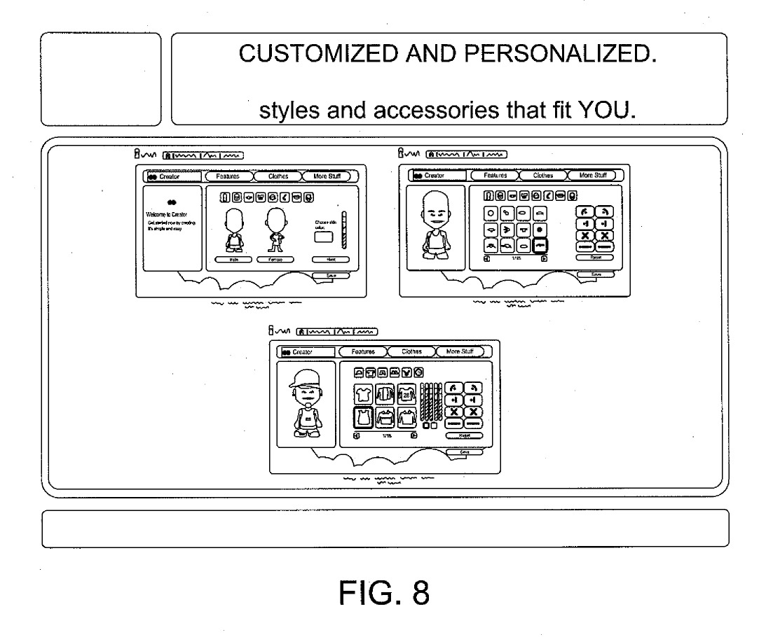

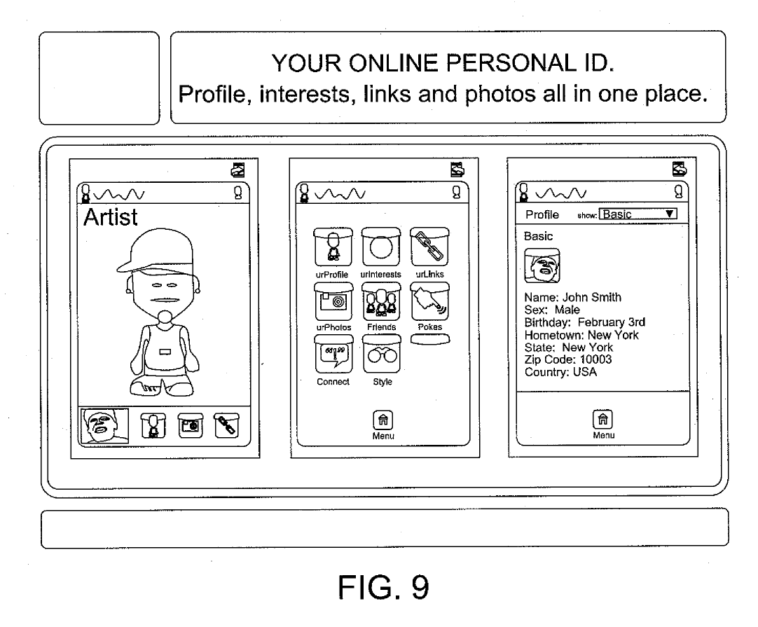

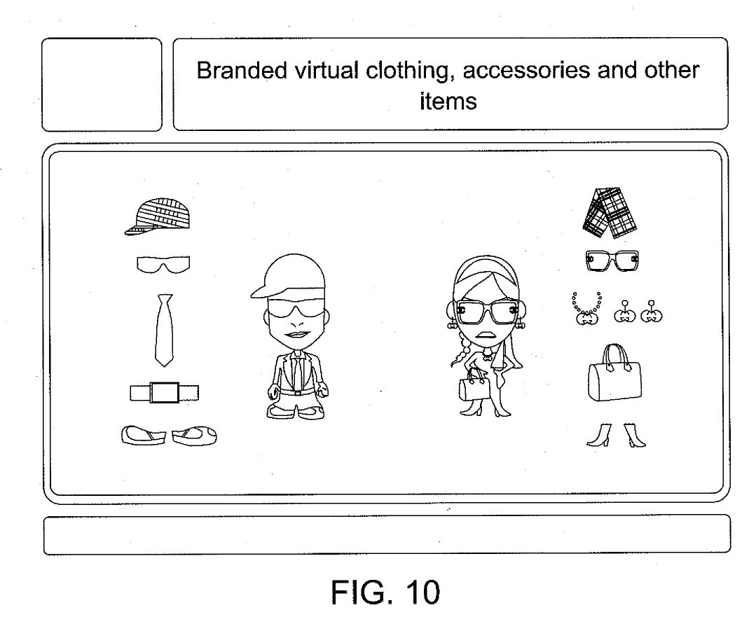

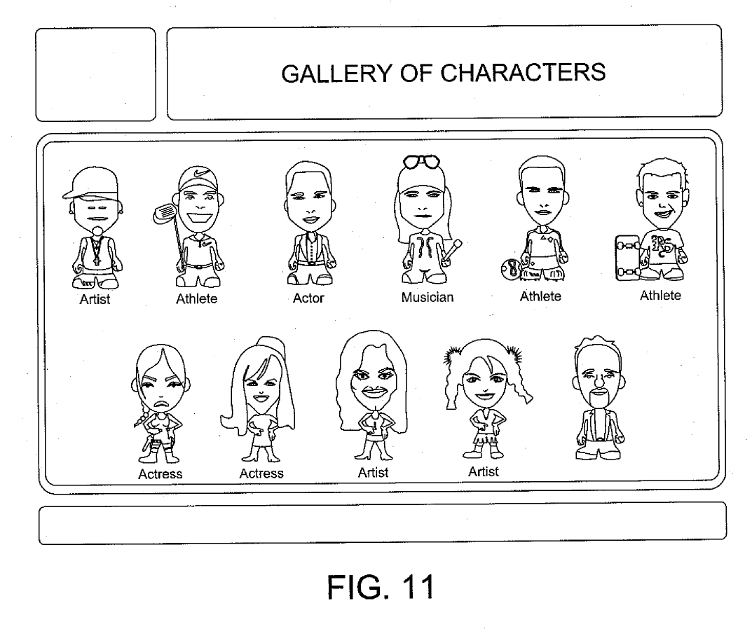

An avatar is understood by one of ordinary skill in the art to include a computer user's representation of him or herself, such as in the form of a two or three dimensional model used in computer games, social network applications, or other on-line communities. A typical avatar, as illustrated in FIGS. 8-11 may further include, or have associated therewith, a user's name, a user's screen name, a handle, or text of interest, such as a trademark, saying, or poem, for example.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

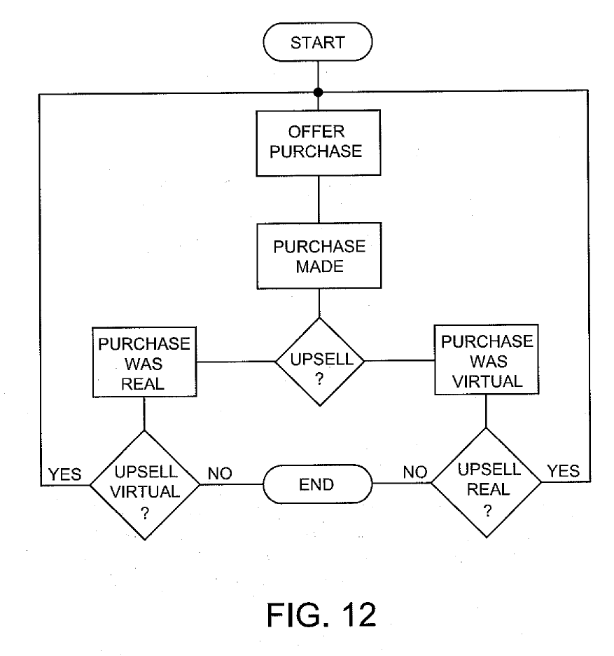

The present invention may include, for presentation in applications, such as web browsers, within or without the aforementioned application space, a fully portable, widgetized avatar having associated therewith multiple items of social information that are generally requested for association with at least two different computing communities or transactions. Widgetization of the avatar of the present invention necessarily allows for portability of the avatar of the present invention. Further, a myriad of additional information may be associated with the avatar, wherein such information is generally required or desired for use in computing communities or transactions. This information may be organized into multiple levels of detail, and/or multiple levels of accessibility to third parties in a computing community or transaction, and may include likes or dislikes, such as musical or motion picture tastes, job or educational status, age, location, income, marital status, and other computed communities with which that user is associated, associated with his or her avatar. Such user preference information may, for example, allow for an Upsell, or improved sale, as illustrated in FIG. 12.

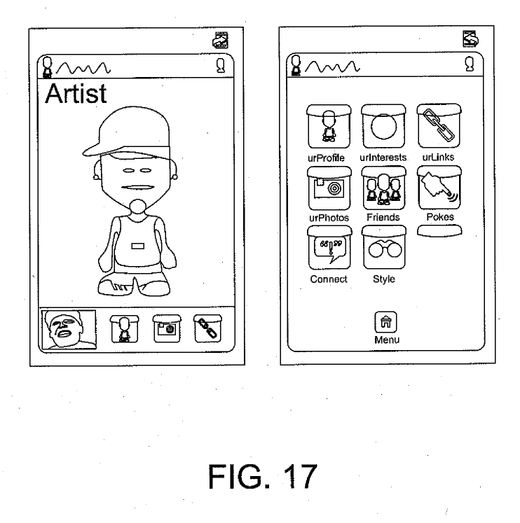

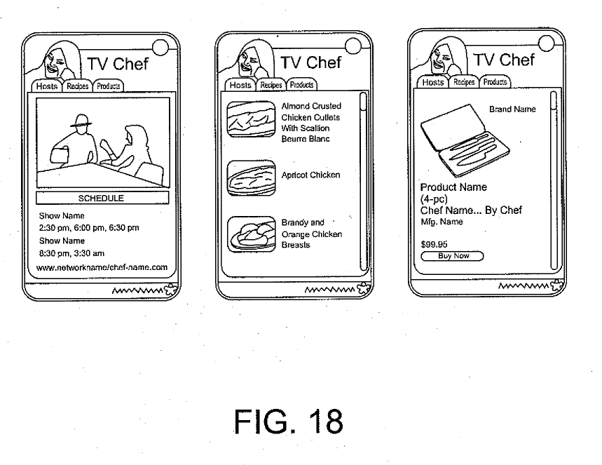

Needless to say, the computing code that provides for the virtual manifestation may be provided in a such a normalized format that it is easily adopted into multiple computing communities, across multiple of the aforementioned operating systems, and/or may be adopted as non-static content onto multiple different web pages. As such, the subject avatar may be incorporated into any social communities, fantasy sports communities, blogs, and the like, simultaneously. Further, avatars of particular interest to the general public, such as trading card avatars of musical artists or other famous persons, such as those shown in FIGS. 17 and 18, may be downloaded or referenced by fans of such famous persons. Such “celebrity” avatars, including in such non-classical formats, may include presentations or allow for interactions with celebrity suggestions or favorites, such as recipes, music, concerts, movies, talk shows, reality shows, or the like, and may further allow for purchases from or related to such suggestions or favorites. As such, preferred presentation of such avatars may be among the premier marketing opportunities discussed hereinabove if employed with a “hard coded” hypervisor application space embodiment. Further, such marketing opportunities may include a tool whereby physical features, clothing, accessories, and activities of an avatar may be taken from the real world and “virtualized” for “hard coded” hypervisor-mandated presentation. As such, virtualized items may be made available for sale for use with an avatar just as the corresponding real items are generally for sale for use with the real world user correspondent to the avatar. Likewise, celebrity avatars may be presented as “model” widgetized avatars, and the user may be enabled to purchase those items worn by the celebrity's avatar, and/or that are endorsed by that celebrity. Additionally, this may allow for an upsell engine that may operate, upon purchase of a virtual item for association with the user's avatar, to present the user with an opportunity to purchase the same or similar article in the real world for real world use by the actual user based on that user's known preference for that article as evidenced by the purchase of the virtual article for use with the user's avatar, or vice versa. The upsell engine may additionally or alternatively include presentation to the user of an advertisement for real world articles that are the same as or associated with the virtual article purchased by the user, or may allow for presentation of advertising related to likely related virtual or real world articles of interest to the user based on the user's expressed preference for the particular virtual article selected.

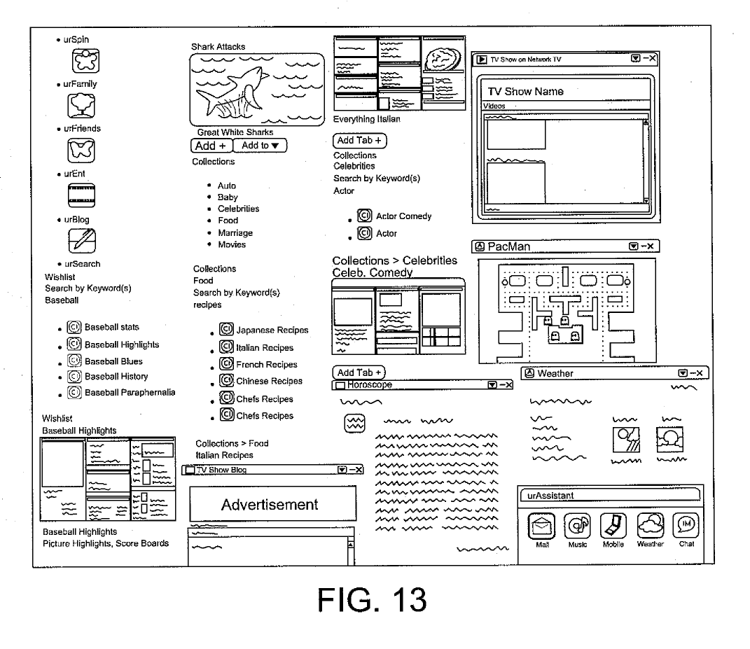

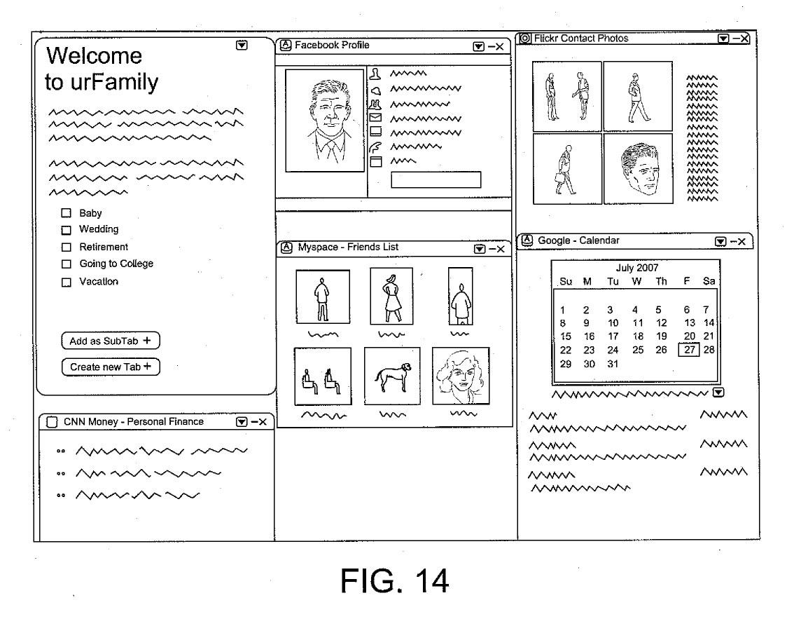

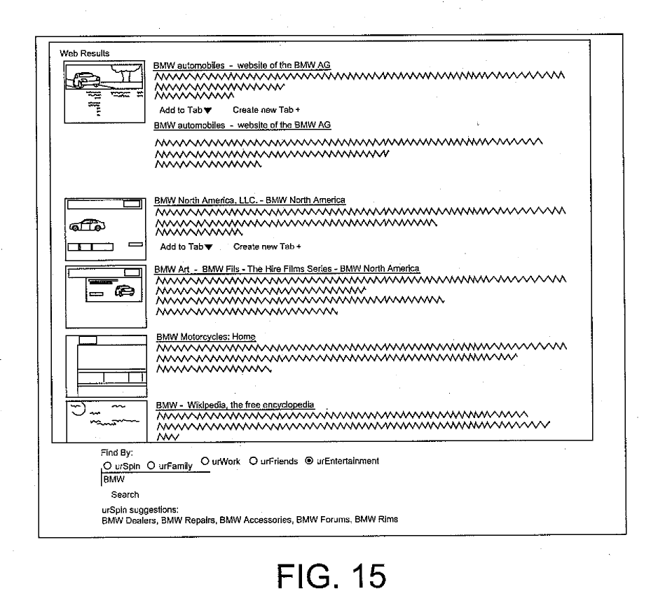

Further, the present invention may allow for association of particular levels of expertise with particular areas of interest as related to the avatar, as illustrated in FIGS. 13-15. Thus, searches may be made available in one or more computing communities for persons having desired levels of expertise in certain areas. Thus, a search by a party in need, such as a key word or wish list search, for an expert or information accumulated by an expert in a particular area may return not a user advertising to be an expert in a particular area, but instead may return a user and/or information objectively adjudged to be expert information in a particular area.

Thus, the avatar of the present invention enables a user to create a portable, fully virtual, “person” for association with that user and carrying the characteristics of that user, including a personal profile and identification card that can be used in combination with any web page, web top or desk top and any computing community, transaction or social networking situation. Thereby, the avatar of the present invention allows users to connect with other users and share ideas, content, expertise, and applications. Further, the avatar of the present invention thus assists in viral growth by offering users of certain or multiple computing communities an avatar that keeps all personal profile information in one transportable place. Additionally, the avatars of the present invention may provide a foundation for a recommendation and expertise engine employing an algorithm that may suggest content or an expert based on a user's community, popularity, known expertise, clicks, interests, searches, or the like.

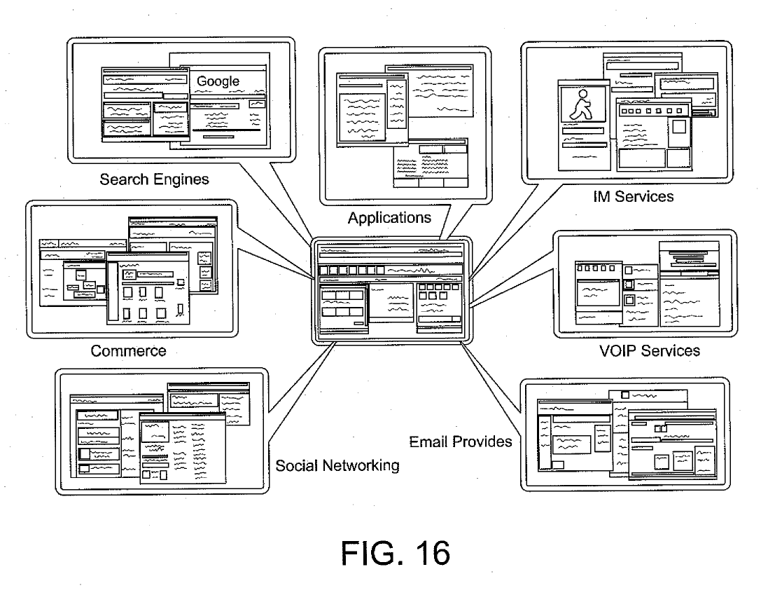

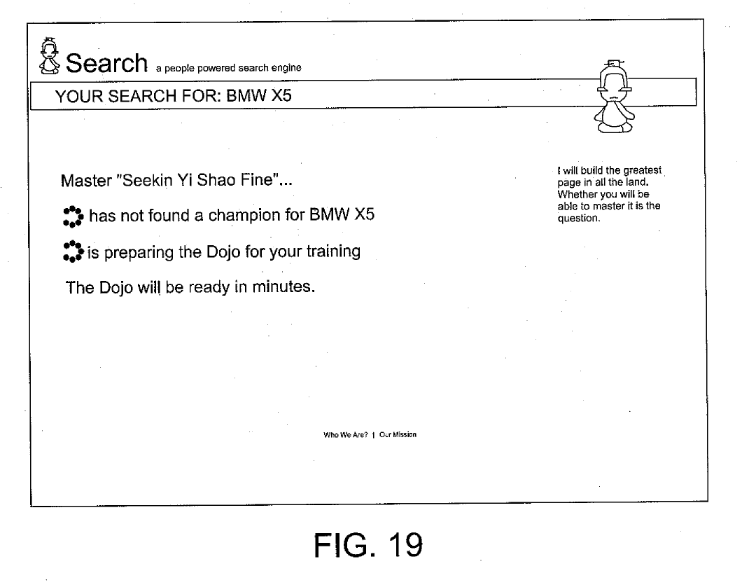

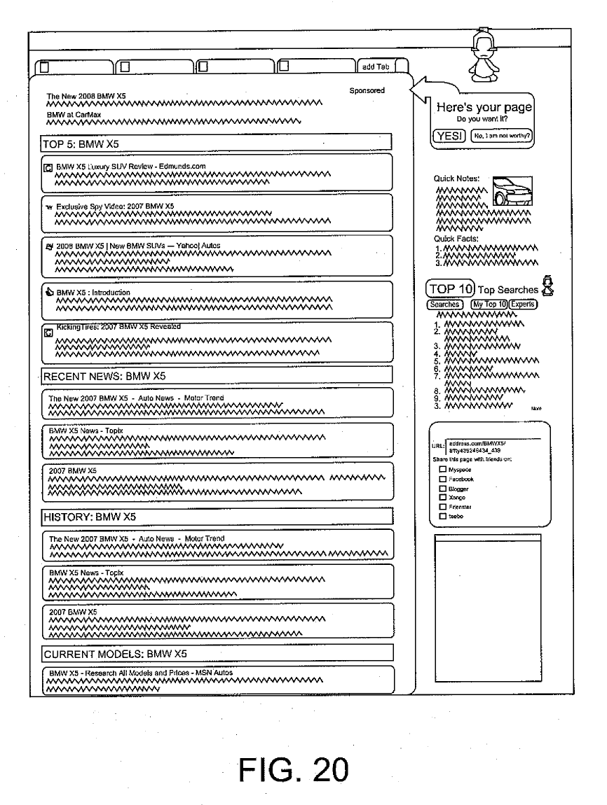

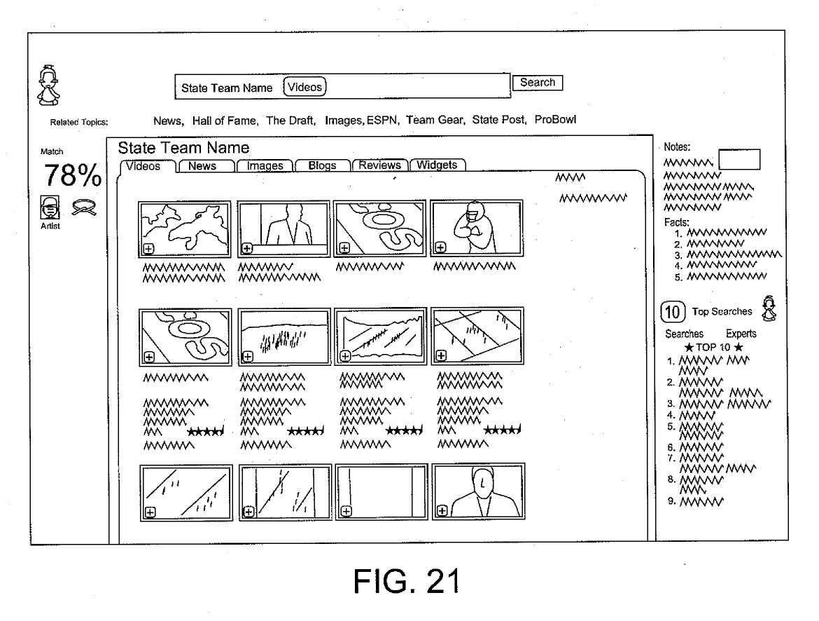

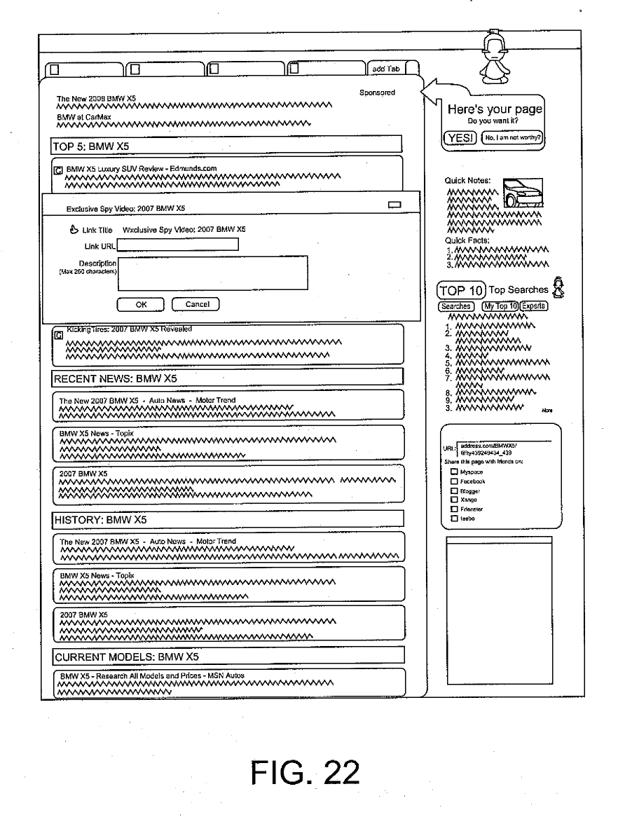

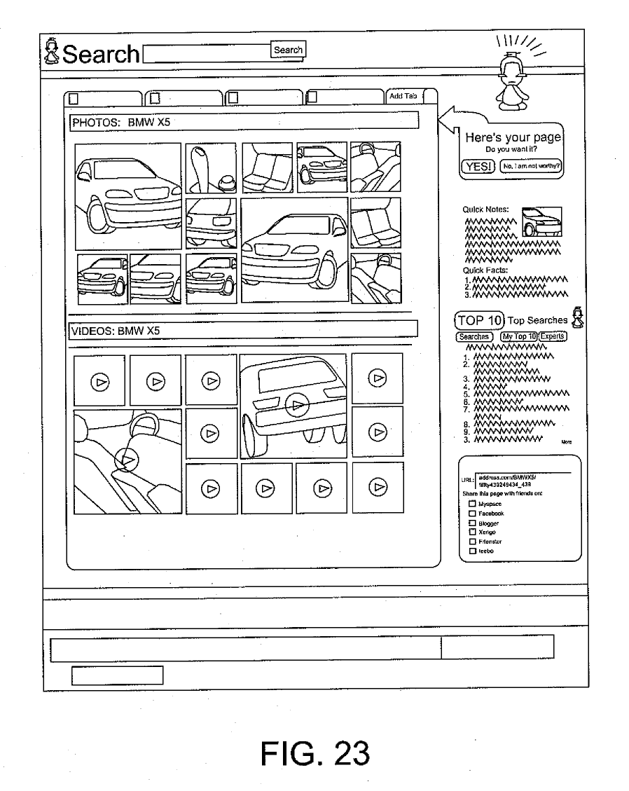

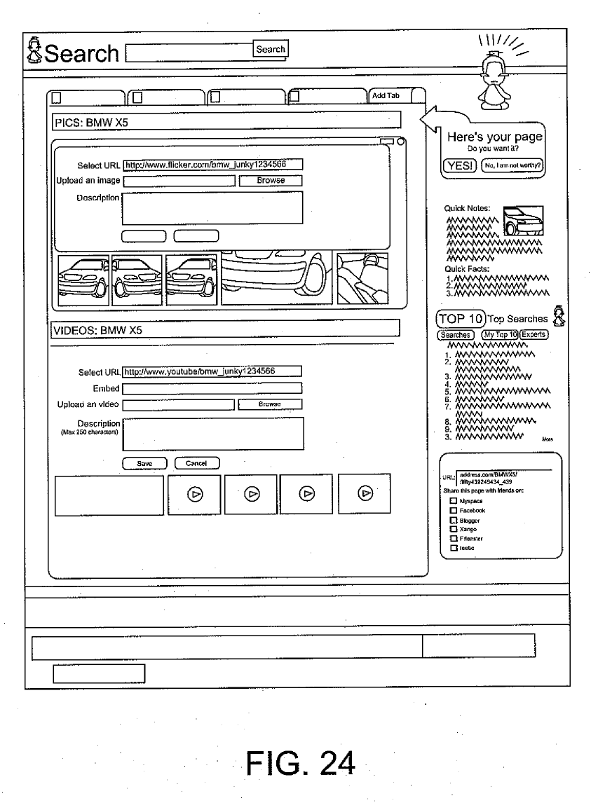

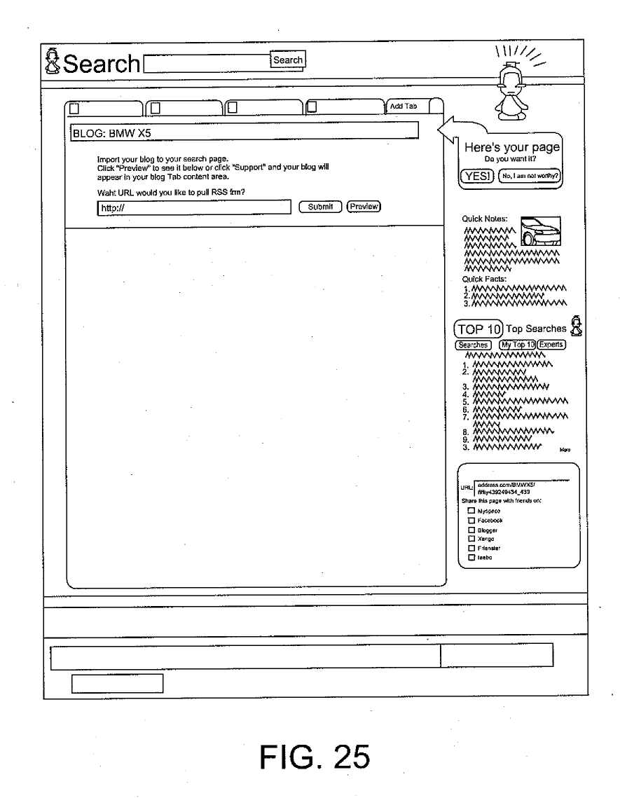

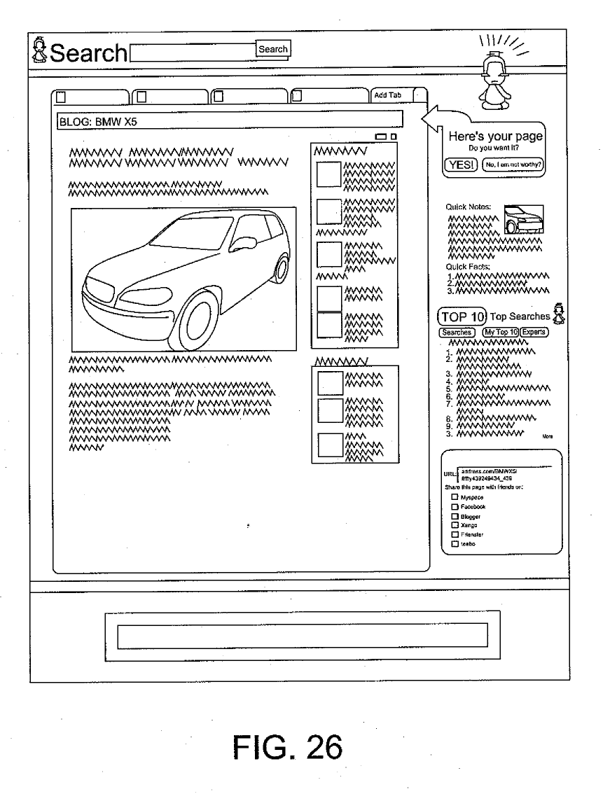

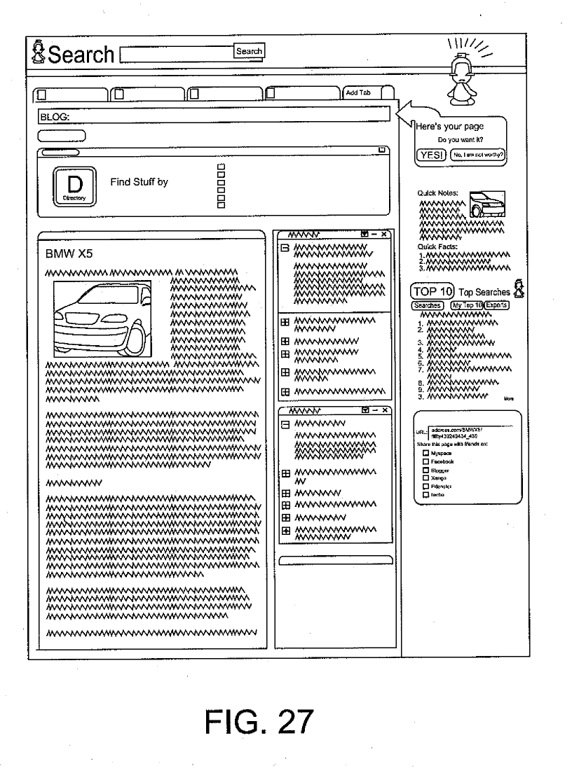

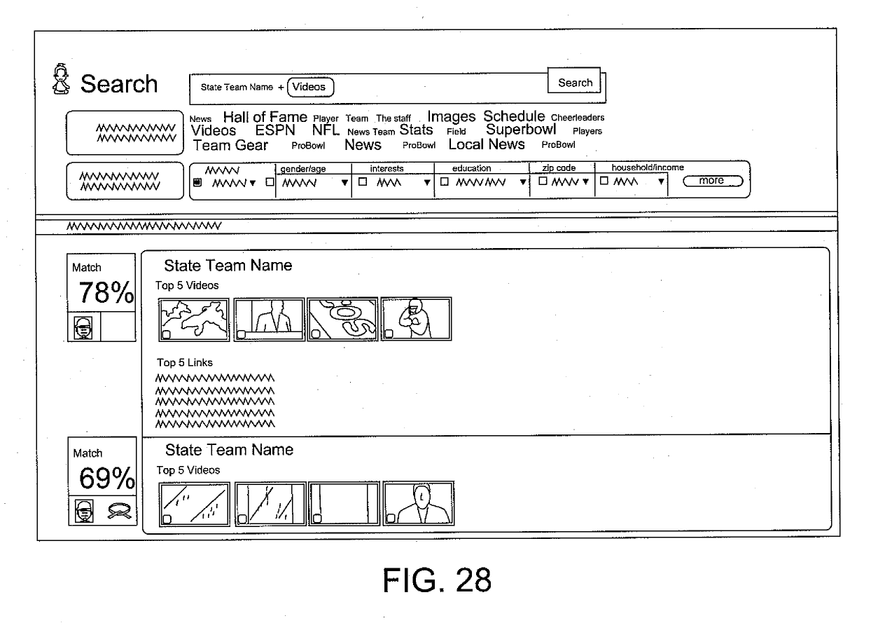

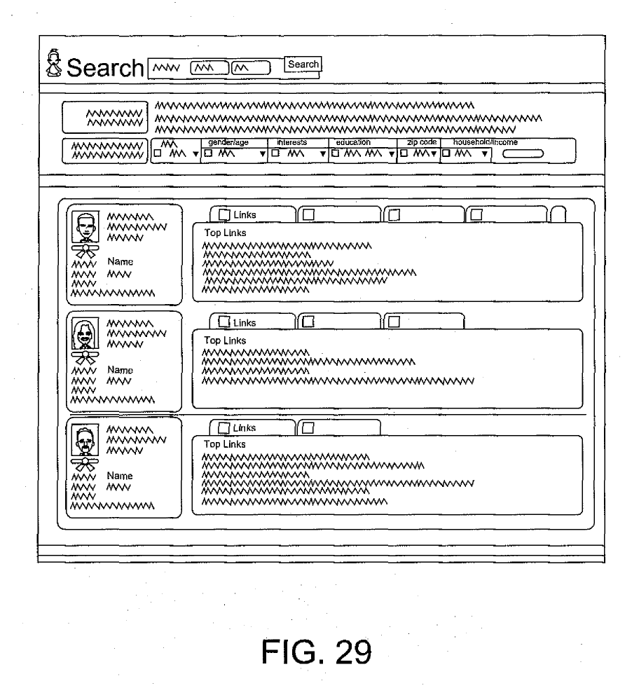

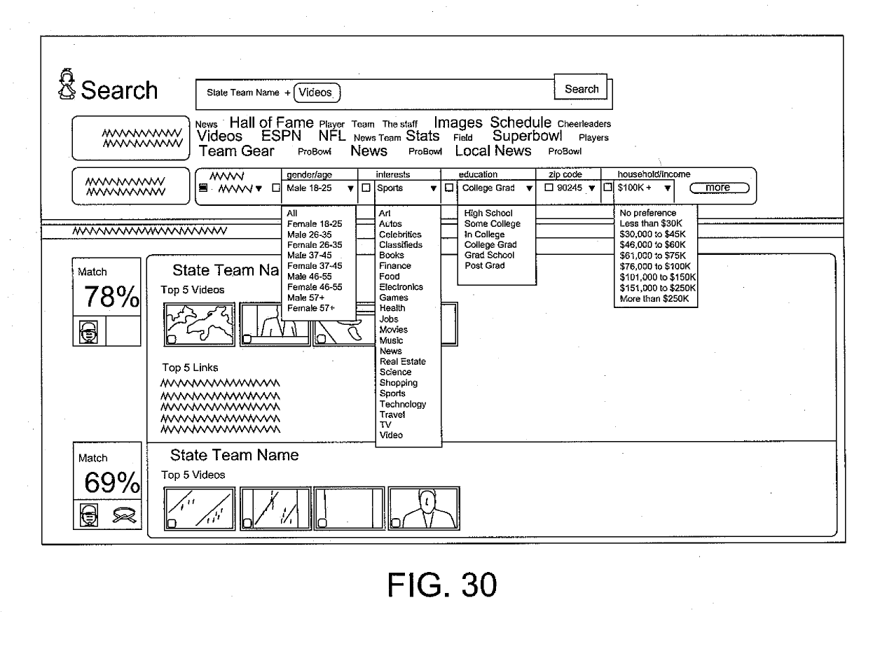

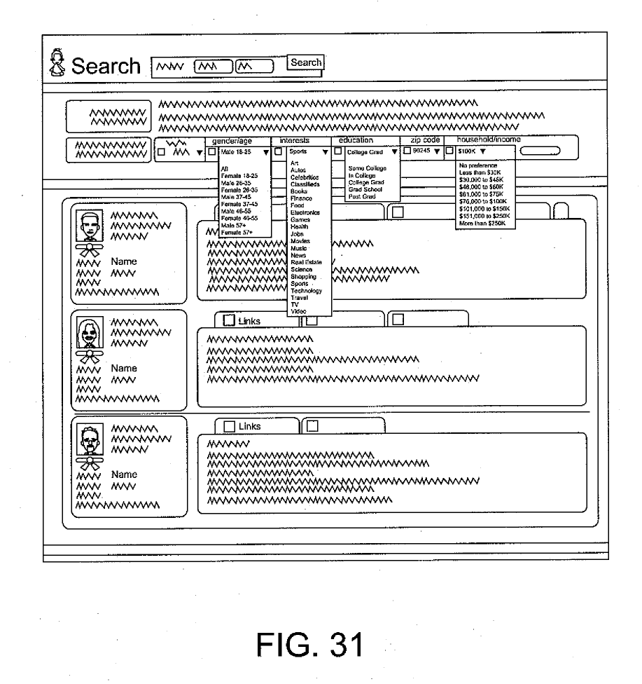

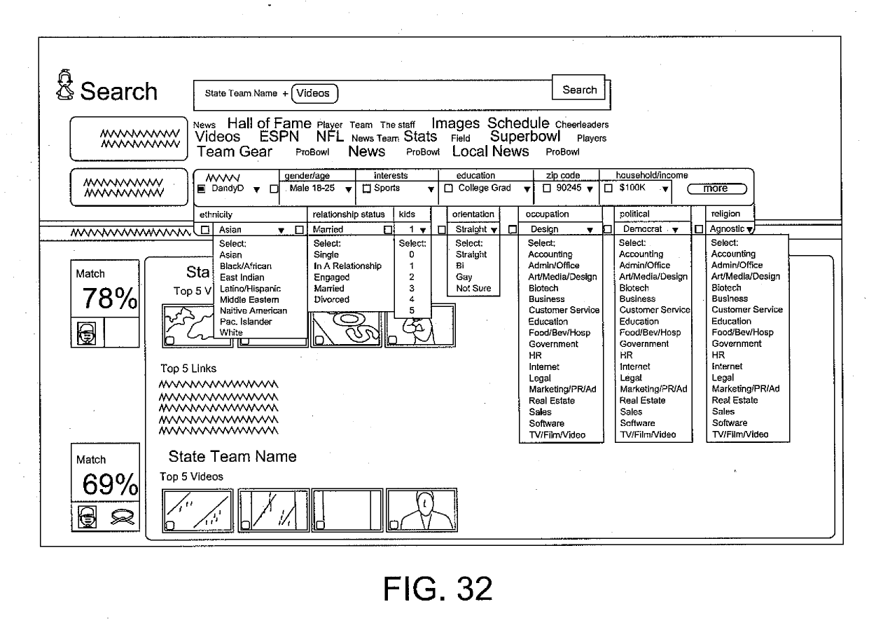

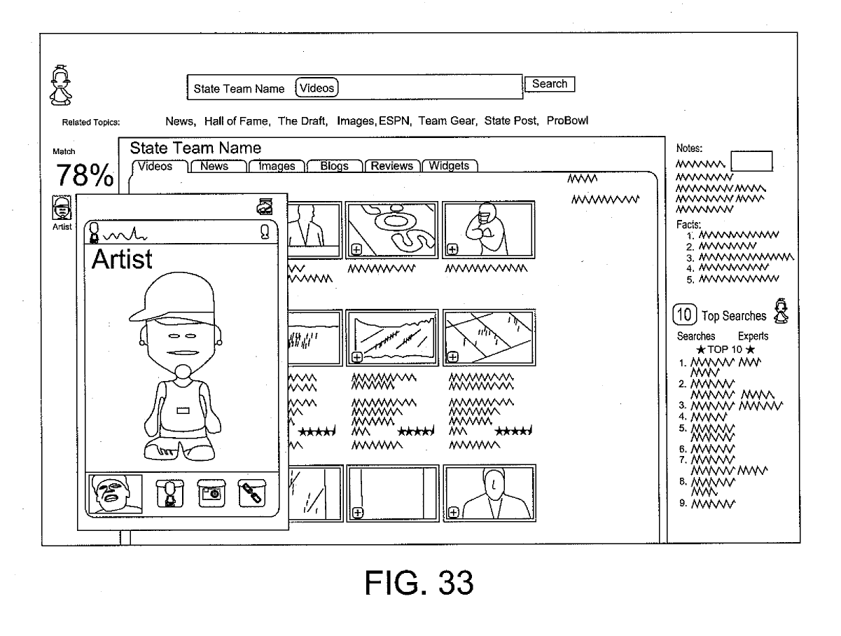

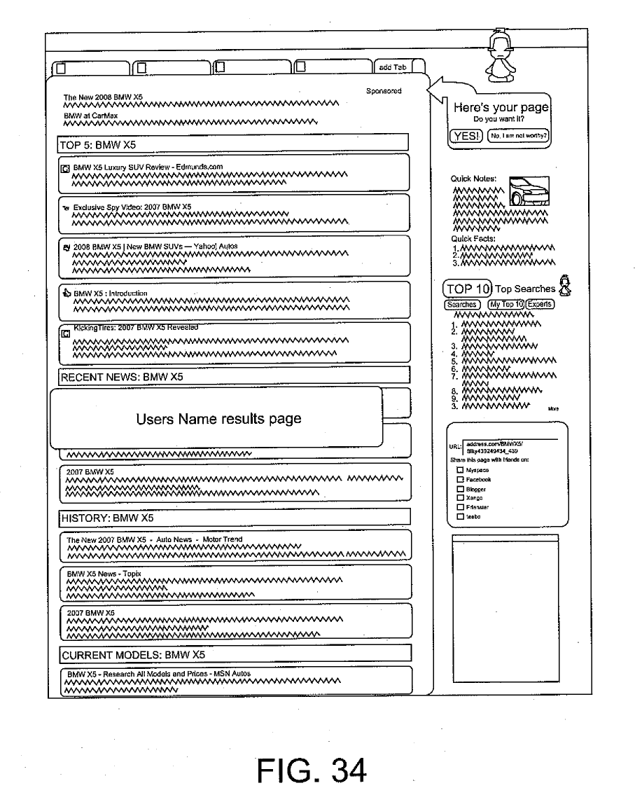

The present invention, such as the hypervisor webtop, may allow, with or without the use of widgets and/or widgetized avatars, the execution of specialized searches, local or remote applications, e-commerce, social networking, and the like, as illustrated in FIG. 16. The specialized search of FIG. 16 may include searching for a “master” in the area searched, such as a person having some increased level of expertise in the searched area in a particular environment, such as on one or more of the user's social networks, and/or may seek search results in accordance with those results found most useful by such “masters.” The execution of such a search, and the results of such a search, including certain deep-linked results of such searches, are discussed hereinafter with respect to FIGS. 19-33.

Needless to say, unlike the aforementioned search types of the present invention, typical keyword search engines are well understood to those of ordinary skill in the art. In the present invention, a hypervisor may allow for a search or wishlist feature to be made available across multiple computing communities, and such a multi-community search engine may, for example, for security purposes, allow a particular user to search only those communities of which that user is a member, and may further allow for such searching in an instant-on environment prior to presentation of aspects of a typical primary operating system with which such searches are usually associated.

In the prior art, subsequent users may, in certain embodiments, access and/or make use of prior searches by prior users of a search engine. However, even in such instances, the subsequent user has no way of knowing of the expertise level of the prior searching user, that is, the subsequent user has no way of knowing if the prior user was an expert, or at least had sufficient expertise to make reusing his or her search worthwhile. Rather, a true expert in a particular area is likely to have record of, such as by book marking, live-linking, or having a page dedicated to, particular links or points of interest that that expert has found helpful. Thus, it is far more useful for the subsequent user to search for an expert or an expert's results, and then make use of the expert's recommended information or search points, than it is for the user who is a non-expert to formulate his or her own search, or reuse a prior search that may or may not have been performed by an expert. Additionally and alternatively, experts in particular fields may advertise their expertise using a hypervisor driven application, such as wherein his or her expertise has been verified by a computing community, and a searching user may search such “advertisements” in order to locate a known expert in a particular field.

Thus, the present invention, at least in part, may provide searching based on the relevancy of a person's expertise to a desired topic on which help is sought, rather than the prior art methodology of keyword searching relating not to people and/or experts, but instead relating merely to websites, things, or advertised services that have no expertise rating associated therewith. Of course, this embodiment of the present invention allows the keyword revenue model of prior art search engines, such as Google®, to be employed in the monetization of searching for true experts that can assist in topical areas, and/or expert information in those topical areas, associated with the particular keywords searched.

Thus, in accordance with the exemplary embodiments set forth herein throughout, the present invention provides an intersection between keywords and expertise in those keywords. As will be apparent to those skilled in the art in light of this discussion, similarities among users increases relevancy for keyword search results, particularly in localized, such as geographic or topical localization, searching, and the advantages gained from this similarity are further heightened when one of the users wishes to gain from the expertise of a similar user in a desired area. Such expertise-based keyword searching is particularly useful in areas in which such unique expertise would generally improve search results, such as in, but not limited to, geographic locality, travel, health, entertainment, cars, lifestyle, education and commerce, for example.

Needless to say, the search capabilities of the present invention may be employed in conjunction with more typical prior art search capabilities, such as a web crawler, to increase the richness of the search results produced. In such an exemplary-embodiment, the results of the present invention and a prior art type search may be presented to the user seamlessly and simultaneously, or may be produced separately to allow the user to assess which methodology has produced the most relevant results. Those skilled in the art will understand that, in the event a searching user is allowed to select between the results of multiple different search types, the type ultimately selected should be indicative of which search method produced the more relevant results. Thereby, tracking which result set is selected by the searching user may be algorithmically employed by the present invention in order to further improve the search results produced by the present invention.

Additionally, with regard to support and security discussed hereinabove, the present invention may provide a configuration for monitoring the aspects of a computer system such that, upon an alert on a given component, the contents of that component may be archived and a replacement component may be ordered/shipped for replacement installation. Each of the myriad of components of computer system may be monitored as described herein throughout. Information, in the form of alerts or the underlying monitored data, may, for example, be sent to a central processing facility, such as based on an instruction from the hypervisor. Central processing facility, may interpret the sent information and perform actions based on the information, such as automatically ordering parts or computers for users, downloading data to a backup, and the like. Thereby, central processing may perform data backup, may order replacement parts, and/or may alert the user or owner of computer system of potential issues, for example.

For example, the hypervisor may, such as via the BIOS, monitor the power supply of a desktop and/or the battery of a laptop. It is generally well understood that many of the problems that terminate a computer's existence are the result of power fluctuations. There are several well known causes of battery/power supply failures which are high or uneven battery temperatures, inaccurate float charge voltage (the overcharge or undercharge problem), loose intercell links or connections, loss of electrolyte due to cracked or bowed cases, lack of maintenance, and plate corrosion. Therefore collecting, monitoring and reporting information on the battery/power supply resistance, the overall voltage, cell voltages, ambient temperatures, cell temperatures, float current, discharge current, string currents and discharge times may help to prolong computing life.

In addition, many of the other known BIOS functionalities may be monitored to provide information on the status of various computer systems. Using the BIOS information also provides information regarding the configuration of the computer itself, such that BIOS-identified devices are known to exist and may be monitored and have the status thereof reported. Further, monitoring may include monitoring the fan speed, monitoring the temperature of the mother board, monitoring software health, such as the presence of viruses, worms, or the like, by way of non-limiting example only. In particular, by way of non-limiting example only, the various system temperatures, CPU temperature, CPU fan speed, Power supply fan speed, CPU core voltage, I/O voltage, various operating voltages, standby voltage and the like may be monitored. Further, various hardware may be monitored, such as, by way of non-limiting example only, video cards, network cards, sound cards, USB controller, RAM. The network's health may also be monitored. This may be an important function as the network may provide an avenue to alert users and/or the central processing facility that an error may be imminent.

Once the global monitoring of the BIOS, and, in certain embodiments, additionally the operating system, software, and external devices, detects an “out of specification” result, according to an aspect of the present invention, the system may notify the central processing facility of the detected result. In such a situation, the facility may be linked via the network, via a virtual network, such as a thin client, or the like, for example.

It is also an aspect of the present invention that the monitoring portions of the invention perform monitoring and report the monitored information solely to the central processing facility, and such central processing facility determines if a given specification or set of specifications is out of specification. Thereby, manufacturer specific exclusive data set-types will not be disclosed locally to the computer user, but need be known only at the central processing facility.

Once notified, the central monitoring station may perform a number of actions. These actions may include copying information from the local disk drive to a remote backup disk drive, forcing the local machine to copy to a local backup drive, ordering a replacement part, or alerting the user/owner of the local computer that an error is expected to occur. Decisions on the action taken may be determined based on the notification result that has been detected, as well as the likelihood of an error and what error is suspected of eventually occurring.

Further, the present invention may include a widget constituting a discreet portion of a favored user experience that may be applied to a desktop, web top and/or the aforementioned hypervisor webtop experience to personalize such a desktop or web top experience to that particular user. Further, such widgets in the present invention may allow for transport of a favored user experience to other user experience locations, such as computing communities and/or social networking sites, in order to improve that user's experience of such other sites or network locations. Needless to say, as used herein a network or network experience is and includes an internet, intranet, extranet, telecommunications network, and any other network experience that allows for importation of the widget concept.

In an exemplary embodiment of the present invention, the widgets may be located by a user, or designed by a user, in accordance with preferred techniques. Such preferred techniques may include, for example, in the case of the user-defined widget, the provision of widget templates, into which a user may develop that user's own unique widgets by using discreet physical locations within such template to place code for the subject widget in an overall widget physical format provided by the template.

Additionally, a library of existing widgets may be designed to be made available to improve the user experience upon use of a particular web top or desktop. Such a library may be available via a particular website, via a web top application, via a desktop application, or via discreet application, for example.

In order to provide further flexibility and ease of user experience, such a widget library may be made available to the user in a format that will allow the user to readily locate a widget, widget portions or widgets of interest. For example, a widget directory, such as a hierarchal widget directory, may be provided in accordance with the present invention, and such directory may further be provided with an interface that allows for successive level searching to assist users in finding and adding widgets or widget portions of interest to improve the user's experience. For example, a user may be enabled to search by any one or more of known methods for a widget or widget portion of interest, or all widgets related to a topic of interest, such as by searching alphabetically, by key word, by topical area, and the like, and upon selection of any widget category that the user has sought, the user may be provided with widgets falling into that category, or the user may be provided with an additional set of selectable variables that will allow the widget entities within the library to be further narrowed before presentation to the user for choice by the user.

Additionally, such a user searching feature may include wish lists, hot topics, or collections that may be developed or entered by the user, in which the user may request alerts when desired widgets or widget portions are available, the user may request alerts to the availability of other widgets in another topical area of interest, or the user may wish to aggregate widgets by interest group, or topical keyword, so that the user may have ease of creating and publishing, or downloading, or otherwise accessing in large quantities.

Through the use of the present invention, widgets may be tracked. As such, particular metrics, such as Google® metrics, may be associated with each widget, and the use of each widget. Such tracking information may be provided, such as to the publisher, i.e., the third party creator, of a particular widget, in order that the publisher may be enabled to make an accounting for the use and/or download of the widget. Thereby, payment methodologies may be associated with the use and/or download of the widget.

Additionally, for example, as will be understood by those skilled in the art in light of the discussion herein, in embodiments wherein the certain characteristics of a user are known to the search engine of the present invention, the downloading of widgets in accordance with the present invention allows for a monitoring of who performed a search, what they deemed most relevant responsive to it, and what was done responsive to that relevance, such as the downloading of a widget.

Further, discretely or in association with the aforementioned tracking of widgets, the use of particular widgets may allow for assumptions with regard to the interest of the downloading user of the subject widget. Thereby, monetization, such as advertising monetization, may be associated with the user of the subject widget, such as by allowing for the presentation to the user of particular advertisements, such as from an advertising server, based on the user's use or download a particular widget. Further, such advertising may be directly associated by the publisher of the subject widget for presentation to the user of the subject widget at predetermined times, or upon predetermined uses of the subject widget.

The hypervisor webtop discussed herein throughout may function and behave much like a traditional PC desktop. However, although the webtop can run entirely inside a traditional web browser, its functionality is not limited to a single device or platform. For example, the webtop may offer drag-and-drop content functionality, web-based centralized storage, and collaboration tools, and thereby the webtop may become the centralized storage and access point for all content and web applications a user desires. The user may access favorite web properties, including multiple sites, IM services, VoIP services, email accounts, and social networking sites, to name a few. Needless to say, each such web property may create a monetizable avenue.

For example, either through the aforementioned webtop, or via a prior art desktop or webtop, users may be provided the capability to create their own content rich widgets, which may be, in whole or in part, sponsored by advertisers. These widgets may, for example, have click through capability to purchase the sponsored product.

Additionally, the webtop discussed herein throughout may include multiple search options, such as those discussed herein throughout and/or multiple search engines, or may present different search options based on any number of factors, such as user characteristics, such as age or income, user preferences, and/or user geographic location. Thereby, monetization from search engine providers may be provided by allowing for the use of different search engines on different devices employing the referenced webtop, i.e. search engine 1 on cell phones and search engine 2 on the internet, and/or the use of different search engines by users in different geographic locations.

Further, the present invention may allow for the presentation of original content, and/or the licensing of third party content and/or content presentation methodologies. Thereby, the present invention allows for a monetization event in capitalizing on advertising revenue when such original and/or licensed content is viewed, such as by a user of the aforementioned webtop.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

What is claimed is:

1. An instant-on environment provided in the range of 8-14 seconds from an initial computing boot, comprising:
a hypervisor instantiated by a BIOS;
at least one application space instantiated by said hypervisor in parallel to, and prior to complete boot of, at least one main operating system; and
a graphical user interface comprising at least one application software, which at least one application software comprises at least one embedded content, launched within said at least one application space.

2. The instant-on environment of claim 1, wherein the instant-on environment is provided in the range of 10-12 seconds.

3. The instant-on environment of claim 1, wherein said graphical user interface comprises a webtop.

4. The instant-on environment of claim 1, wherein the at least one embedded content comprises at least one widget.

5. The instant-on environment of claim 1, wherein said hypervisor directs a networked communication for the BIOS.

6. The instant-on environment of claim 1, wherein the at least one embedded content comprises an advertisement.

7. The instant-on environment of claim 6, wherein the advertisement comprises at least one selected from the group consisting of a banner ad, a text ad and a popup ad.

8. The instant-on environment of claim 6, wherein the advertisement comprises a targeting to an active user of said graphical user interface.

9. The instant-on environment of claim 8, wherein the targeting comprises at least one cookie obtained by said graphical user interface.

10. The instant-on environment of claim 8, wherein the targeting comprises at least one cookie obtained by the operating system.

11. The instant-on environment of claim 6, wherein the at least one advertisement comprises a widget.

12. The instant-on environment of claim 1, wherein the at least one embedded content comprises a network search capability.

13. The instant-on environment of claim 12, wherein the network search capability is associated with a sponsor.

14. The instant-on environment of claim 12, wherein the network search capability presents at least one networked advertisement in association with a search result.

15. The instant-on environment of claim 1, wherein the at least one application software comprises virtual ware.

16. The instant-on environment of claim 15, wherein the virtual ware comprises a remote server access provided by a BIOS executed network link.

17. The instant-on environment of claim 1, wherein said graphical user interface comprises virtual ware.

18. The instant-on environment of claim 17, wherein the virtual ware comprises a webtop, and wherein the webtop comprises remote drag-and-drop content functionality with at least one environment native to the BIOS.

19. The instant-on environment of claim 17, wherein the virtual ware comprises a webtop, and wherein the webtop provides web-based centralized storage.

20. The instant-on environment of claim 1, further comprising a toggle, wherein said toggle switches between said graphical user interface and the operating system, once booted, upon a user instruction.
